(19) United States
(12) Patent Application Publication
(10) Pub. No.: US 2014/0203989 A1
(43) Pub. Date: Jul. 24, 2014

(54) HIGH FREQUENCY (HF)/ULTRA HIGH FREQUENCY (UHF) RADIO FREQUENCY IDENTIFICATION (RFID) DUAL-BAND TAG ANTENNA

(71) Applicant: Electronics and Telecommunications Research Institute, Daejeon (KR)

(72) Inventors: Seung Hwan JEONG, Jeollabuk-do (KR); Won Kyu CHOI, Daejeon (KR); Chan Won PARK, Daejeon (KR); Jong Suk CHAE, Daejeon (KR); Cheol Sig PYO, Daejeon (KR)

(73) Assignee: Electronics and Telecommunications Research Institute, Daejeon (KR)

(21) Appl. No.: 14/100,667

(22) Filed: Dec. 9, 2013

(30) Foreign Application Priority Data
Jan. 22, 2013 (KR) 10-2013-0006990

(51) Int. Cl. H01Q 21/28; H01Q 1/50

(52) U.S. Cl. CPC H01Q 21/28; H01Q 1/50
USPC 343/853; 343/893

(57) ABSTRACT

Provided is a high frequency (HF)/ultra high frequency (UHF) radio frequency identification (RFID) multiband tag antenna that may form a circular HF tag pattern on one surface of a single printed circuit board (PCB) and may form a UHF tag pattern having a diameter greater than a diameter of the HF tag pattern on another surface of the single PCB.

### CROSS-REFERENCE TO RELATED APPLICATION

This application claims the priority benefit of Korean Patent Application No. 10-2013-0006990, filed on Jan. 22, 2013, in the Korean Intellectual Property Office, the disclosure of which is incorporated herein by reference.

### BACKGROUND

1. Field of the Invention

Embodiments of the present invention relate to a high frequency (HF)/ultra high frequency (UHF) radio frequency identification (RFID) multiband tag antenna that may form a circular HF tag pattern on one surface of a single printed circuit board (PCB) and may form a UHF tag pattern having a diameter greater than a diameter of the HF tag pattern on another surface of the single PCB, thereby minimizing a size of a tag and supplementing a decrease in the read range of a UHF tag by the HF tag pattern and thus, providing a full HF and UHF RFID service using a single tag.

2. Description of the Related Art

A radio frequency identification (RFID) tag is used in a variety of fields such as a material management and a security, together with an RFID reader. In general, when an object attached with the RFID tag is disposed in a read zone of the RFID reader, the RFID reader may transmit an integration signal to the RFID tag by modulating an RF signal having a predetermined carrier frequency. In response to reception of the RFID signal, the RFID tag may respond to an interrogation of the RFID reader.

That is, the RFID reader may transmit an interrogation signal to the RFID tag by modulating a continuous electromagnetic wave having a predetermined frequency. The RFID tag may perform backscattering modulation of the electromagnetic wave transmitted from the RFID reader and then return the electromagnetic wave to the RFID reader, in order to transfer information of the RFID tag stored in an internal memory to the RFID reader.

The backscattering modulation may refer to a method of modulating a magnitude and a phase of scattered electromagnetic wave and thereby transmitting information of the RFID tag when the RFID tag scatters the electromagnetic wave transmitted from the RFID reader and thereby returns the scattered electromagnetic wave to the RFID reader.

A passive RFID tag may rectify an electromagnetic wave transmitted from the RFID reader and thereby use the rectified electromagnetic wave as a power source of the passive RFID tag. Accordingly, for a normal operation of the passive RFID tag, strength of a signal received by the RFID tag needs to be greater than or equal to a predetermined threshold.

To enhance the read range of a passive RFID system, transmission power of the RFID reader may be increased. However, the transmission power of the RFID reader is under local regulation of each country including the Federal Communication Commission (FCC) of the U.S.A. and thus, cannot be increased unconditionally.

Accordingly, to maximize the read range with respect to the given transmission power of the RFID reader, the RFID tag needs to efficiently receive an electromagnetic wave transmitted from the RFID reader.

A method of enhancing the efficiency of the RFID tag may include a method of using a separate matching circuit. In general, the RFID tag may include an antenna, an RF frontend, and a signal processor. The RF frontend and the signal processor may be provided as a single chip.

The method of using a matching circuit may be a method of maximizing strength of a signal transferred from an antenna to an RF frontend by performing conjugate matching with respect to the antenna and the RF frontend through a separate matching circuit.

However, a matching circuit configured as a combination of a capacitor and an inductor requires a relatively large area and thus, it may be difficult to include the matching circuit within a chip in terms of a miniaturization and cost.

An HF RFID tag of 13.56 MHz band may have a short read range and provide a high security. A UHF RFID tag of 900 MHz band may have a weak security, but be readable in a distance of 1 m or more.

To control a security zone access and a vehicle, there was an attempt to manufacture two types of RFID tags into a single tag. For example, Korean Patent Application NOs. 10-2009-0024588 and 10-2009-0009524 relate to a method of inserting an HF tag pattern and a UHF tag pattern into a single card type tag and thereby using the card type tag.

The above patents physically combine two patterns, for example, the HF tag pattern and the UHF tag pattern and thus, increase a size of a tag.

Accordingly, there is a need for a technology capable of flexibly combining heterogeneous tag patterns and also reducing the overall tag size.

### SUMMARY

An aspect of the present invention provides a tag antenna for supporting a multiband that may configure a high frequency (HF) radio frequency identification (RFID) tag and a UHF RFID tag on a single printed circuit board (PCB), and may also provide an RFID multiband tag antenna that may independently form an HF tag pattern on one surface of a single PCB and a UHF tag pattern on another surface of the PCB.

An HF band antenna of the present invention may be configured by forming, on one surface of a single PCB, a circular pattern having a predetermined diameter and the number of turns that are suitable for an application. Also, a UHF band antenna may be configured by forming, on another surface of the single PCB, a pattern for radiation and a pattern for matching. A separate RF element for matching a tag chip may be used for the HF band antenna. A separate tuning pattern for adjusting a resonant frequency and impedance may be formed on the UHF band antenna.

Also, another aspect of the present invention is to utilize a portion of a structure of an HF band antenna as a structure of a UHF band antenna by electromagnetically coupling the UHF band antenna and the structure of the HF band antenna. The present invention enables an electromagnetic coupling between the structure of the HF band antenna and the structure of the UHF band antenna to be utilized for configuring an antenna.

Also, an aspect of the present invention is to form a separate pattern capable of adjusting a resonant frequency of an antenna and impedance of the antenna using a pattern of a UHF band antenna.

An antenna provided by the present invention and an RFID tag using the antenna may be employed for a place requiring an integrated operation of HF/UHF RFID application service, for example, a company pass, a cafeteria management, a management of medical supplies, and a casino game room.

In particular, the casino game room simultaneously requires an HF RFID service for reading within a restricted area, such as batting of a game chip, and a UHF RFID service for remote reading for detecting an illegal take-out of a game chip. An aspect of the present invention is to flexibly provide an RFID tag capable of satisfying such requirements.

According to an aspect of the present invention, there is provided a tag antenna, including: a substrate to form an HF tag pattern on a first surface and a UHF tag pattern on a second surface different from the first surface; and a feed terminal to supply power to each of the HF tag pattern and the UHF tag pattern.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a block diagram illustrating a radio frequency identification (RFID) system according to an embodiment of the present invention;

FIG. 2 is an equivalent circuit diagram modeling a tag antenna and a radio frequency (RF) frontend according to an embodiment of the present invention;

FIG. 3 is a block diagram illustrating a high frequency (HF)/ultra high frequency (UHF) multiband tag antenna according to an embodiment of the present invention;

FIG. 4 is a diagram describing a tag antenna according to a principle of the present invention;

FIG. 5 is a diagram illustrating an example of a tag antenna according to an embodiment of the present invention; and

FIG. 6 is a graph illustrating an example of a result of testing a return loss according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures, but the present invention is not limited thereto or restricted thereby.

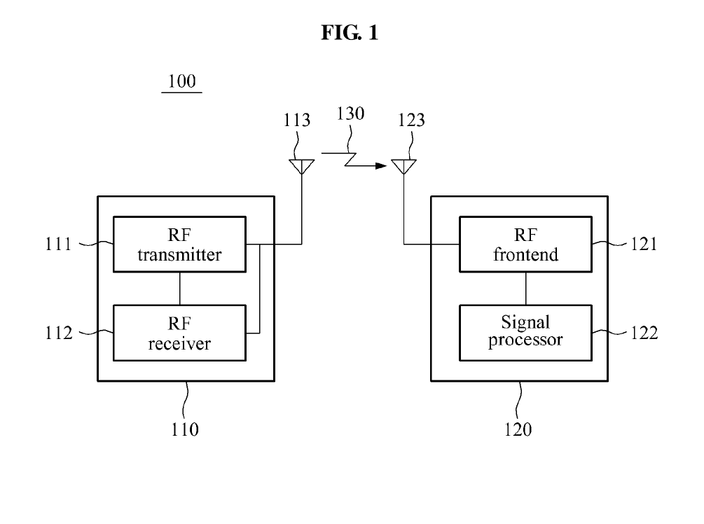

FIG. 1 is a block diagram illustrating a radio frequency identification (RFID) system 100 according to an embodiment of the present invention.

Referring to FIG. 1, the RFID system 100 may include an RFID tag 120 to store unique information and an RFID reader 110 to perform a reading and interpreting function.

Also, the RFID system 100 may further include a host computer (not shown) to process data read from the RFID tag 120 through the RFID reader 110.

The RFID reader 110 may include a radio frequency (RF) transmitter 111, an RF receiver 112, and a reader antenna 113. The reader antenna 113 may be electrically connected to the RF transmitter 111 and the RF receiver 112. The RFID reader 110 may transmit an RF signal to the RFID tag 120 through the RFID transmitter 111 and the reader antenna 113. Also, the RFID reader 110 may receive the RFID signal from the RFID tag 120 through the reader antenna 113 and the RF receiver 112. A configuration of the RFID reader 110 is known in the art and thus, a detailed description related thereto will be omitted (see U.S. Pat. No. 4,656,463).

The RFID tag 120 may include an RF frontend 121, a signal processor 122, and a tag antenna 123 provided by the present invention. When the RFID tag 120 is provided in a passive type, the RF frontend 121 may convert the received RF signal to direct current (DC) voltage, and may supply power required for operation of the signal processor 122. Also, the RF frontend 121 may extract a baseband signal from the received RF signal. A configuration of the RF frontend 121 is known in the art and thus, a further detailed description related thereto will be omitted (see U.S. Pat. No. 5,942,987).

Referring to an operation of the RFID system 100, the RFID reader 110 may transmit an interrogation to the RFID tag 120 by modulating an RF signal having a predetermined carrier frequency. The RF signal generated at the RF transmitter 111 of the RFID reader 110 may be externally transmitted in a form of an electromagnetic wave 130 through the reader antenna 113.

The electromagnetic wave 130 may be transferred to the tag antenna 123, and the tag antenna 123 may transfer the electromagnetic wave 130 to the RF frontend 121. When magnitude of the RF signal transferred to the RF frontend 121 is greater than or equal to a minimum power required for operation of the RFID tag 120, the RFID tag 120 may respond to the interrogation of the RFID reader 110 by performing backscattering modulation of the electromagnetic wave 130 transmitted from the RFID reader 110.

To improve the read range of the RFID system 100, the tag antenna 123 may need to be capable of efficiently transferring the electromagnetic wave 130 to the RF frontend 121 without causing loss. To this end, there is a need to perform conjugate matching of the impedance of the tag antenna 123 and the impedance of the RF frontend 121.

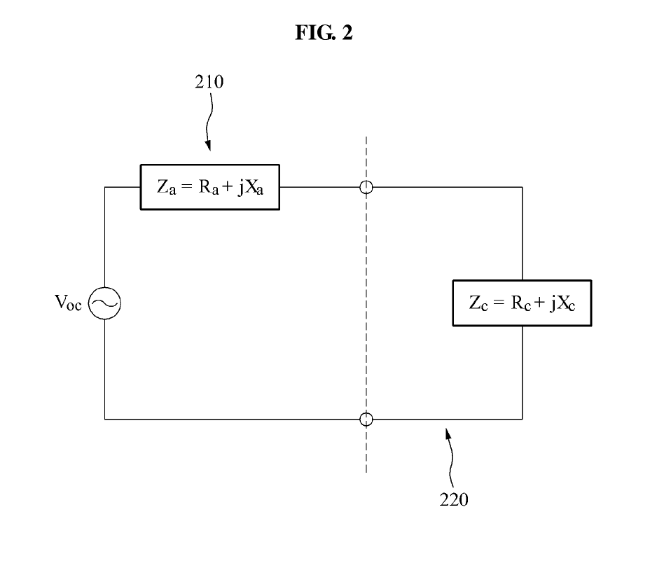

FIG. 2 is an equivalent circuit diagram modeling the tag antenna 123 and the RF frontend 121 according to an embodiment of the present invention.

Referring to FIG. 2, an equivalent circuit may include a power source V_{oc}, antenna impedance Zₐ, and RF frontend impedance Z_{c}. The power source V_{oc} and the antenna impedance Zₐ may correspond to an equivalent circuit 210 of the tag antenna 123 and the RF frontend impedance Z_{c} may correspond to an equivalent circuit 220 of the RF frontend 121.

The antenna impedance Zₐ may have a resistance component Rₐ and a reactance component Xₐ. The RF frontend impedance Z_{c} may have a resistance component R_{c} and a reactance component X_{c}.

In general, in the case of performing conjugate matching of the antenna impedance Zₐ and the RF frontend impedance Z_{c}, maximum power may be transferred from the tag antenna 123 to the RF frontend 121. Here, conjugate matching is to enable two complex impedances to have the same absolute impedance value and have opposite phase signs. That is, when the impedance of the tag antenna 123 or the impedance of the RF frontend 121 is adjusted to satisfy ‘Rₐ=R_{c}’ and ‘Xₐ=−X_{c}’, the maximum power may be transferred from the tag antenna 123 to the RF frontend 121.

In general, the RF frontend 121 of a passive and semi-passive RFID tag chip may include a rectification and detection circuit using a diode, and may not include a separate matching circuit to reduce a chip area. Accordingly, the impedance of the RF frontend 121 may have different impedance different from general 50Ω, and may have a small resistance component R_{c} and a large capacitive reactance component X_{c} in a UHF band due to a characteristic of the rectification and detection circuit.

Accordingly, the antenna impedance Zₐ for the conjugate matching may need to have a small resistance component Rₐ and a large inductive reactance component Xₐ.

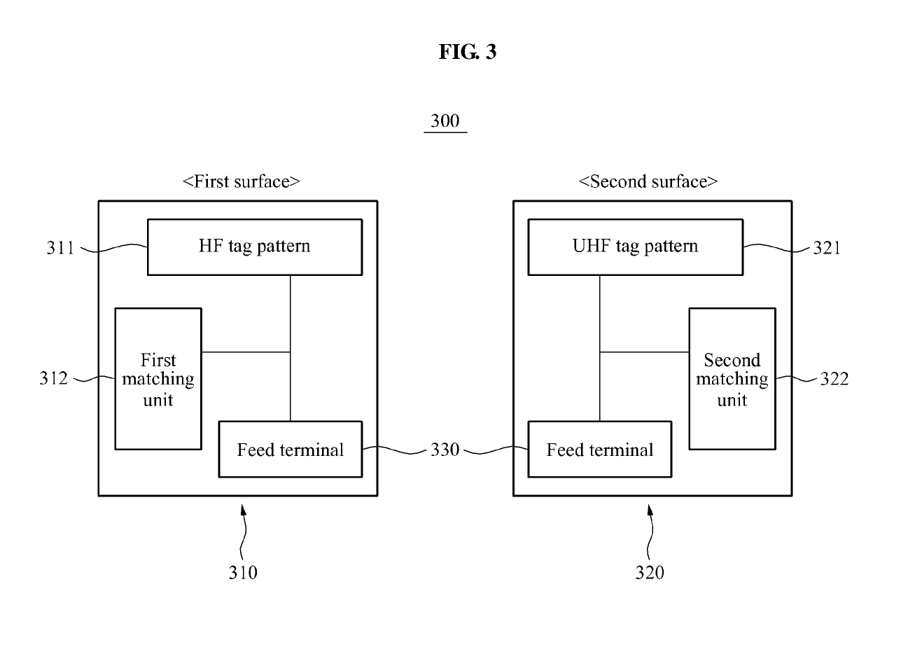

FIG. 3 is a block diagram illustrating an HF/UHF multiband tag antenna (hereinafter, referred to as a tag antenna) 300 according to an embodiment of the present invention.

Referring to FIG. 3, the tag antenna 300 may include a substrate including a first surface 310 and a second surface 320 and a feed terminal 330. Also, depending on embodiments, the tag antenna 300 may further include a first matching unit 312 and a second matching unit 322.

Initially, the substrate may form an HF tag pattern 311 on the first face 310 and form a UHF tag pattern 321 on the second surface 320 different from the first face 310. The substrate may be, for example, a printed circuit board (PCB), and may be a means to transfer an electrical signal through a cooper circuit or an ultra thin film optical circuit.

The first surface 310 may be a predetermined single surface, for example, a top surface or a bottom surface of the substrate. At least a portion of the first surface 310 may be formed as the HF tag pattern 311. That is, the first surface 310 may configure the HF tag pattern 311 having an HF band antenna function in a ring shape that maintains a constant curvature.

The second surface 320 may be another surface of the substrate, for example, the bottom surface when the first surface 310 is the top surface, and may form the UHF tag pattern 321. The UHF tag pattern 321 formed on the second surface 320 may be configured to have a diameter greater than a diameter of the HF tag pattern 311. Through this, a miniaturization of the overall tag size may be achieved. Also, the UHF tag pattern 321 may be connected to the HF tag pattern 311 through electromagnetic coupling. To this end, the UHF tag pattern 321 may form a radial structure or a circular structure similar to the HF tag pattern 311.

Also, the UHF tag pattern 321 may perform conjugate matching with respect to impedance of the RF frontend 121 that converts an RF signal to DC voltage. Through the conjugate matching, although the read range increases, the UHF tag pattern 321 may transfer the RF signal to the RF frontend 121 by minimizing loss.

The feed terminal 330 may supply power to each of the HF tag pattern 311 and the UHF tag pattern 321. That is, the feed terminal 330 may be independently formed on the first surface 310 and the second surface 320 to supply power to each pattern, thereby enabling an antenna function by a pattern.

Therefore, according to the present invention, there may be provided a tag antenna that may provide an HF and UHF RFID application service using a single tag by miniaturizing a tag size through forming an HF tag pattern on one surface of a single PCB and forming a UHF tag pattern having a diameter greater than a diameter of the HF tag pattern on another surface of the single PCB, and by supplementing a decrease in the read range of a UHF tag by the UHF tag pattern.

The tag antenna 300 may further include the first matching unit 312 to determine the impedance of the HF tag pattern 311 by adjusting at least one of the number of turns on the HF tag pattern 311 and an LC resonance value by a capacitor.

The tag antenna 300 may further include the second matching unit 322 to determine the impedance of the UHF tag pattern 321 by adjusting at least one of a length and a width of a feed loop that connects the UHF tag pattern 321 and the feed terminal 330.

The second matching unit 322 may include a first slot to adjust the length of the feed loop and a second slot to adjust the width of the feed loop. At least one of the first slot and the second slot may be detachably attached to the feed loop.

Also, the second matching unit 322 may further include a third slot to adjust the length of the UHF tag pattern 321. Accordingly, when the impedance of the UHF tag pattern 321 and the impedance of the HF tag pattern 311 satisfy a predetermined condition, the third slot may be detachably attached to the UHF tag pattern 321 so as to have a length corresponding to an operating frequency.

The second matching unit 322 may determine a reactance component in the impedance of the UHF tag pattern 321 based on the length of the feed loop. Depending on embodiments, the second matching unit 322 may determine a resistance component in the impedance of the UHF tag pattern 321 based on the length of the feed loop and the width of the feed loop.

Through this, the tag antenna of the present invention may flexibly determine an optimal antenna characteristic by adjusting a length and a width of a pattern to be suitable for a using frequency.

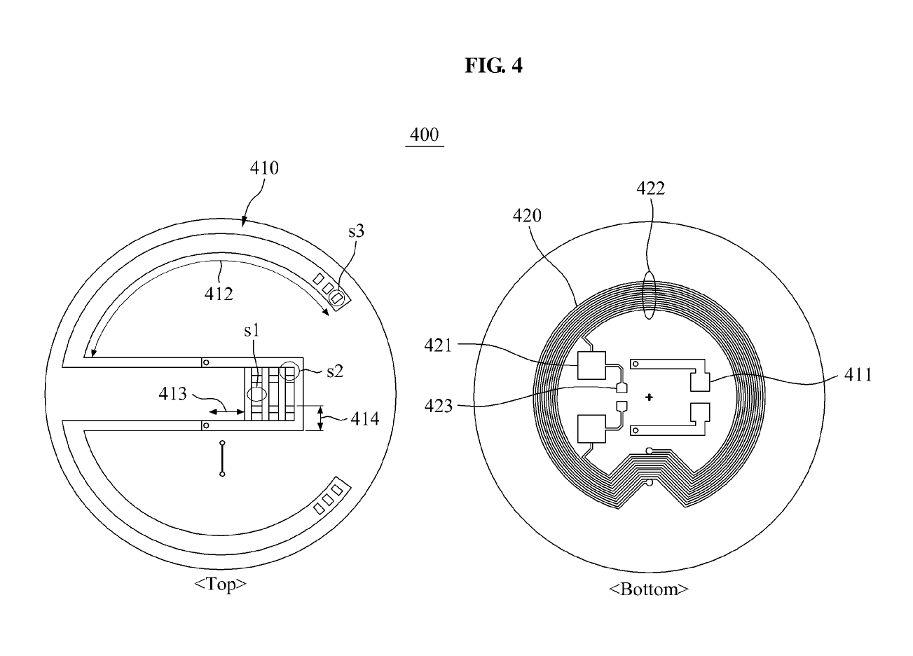

FIG. 4 is a diagram describing a tag antenna 400 according to a principle of the present invention.

Referring to FIG. 4, the tag antenna 400 may include a UHF tag pattern 410 formed on a top surface and an HF tag pattern 420 formed on a bottom surface. A UHF tag feed terminal 411 and an HF tag feed terminal 421 for feeding a tag chip may be formed on the bottom surface.

An antenna impedance matching of the HF tag pattern 420 may follow a general method of adjusting the number of turns 422 of a tag and LC by mounting a capacitor to a capacitor mounting portion 423. Impedance Zₐ of the UHF tag pattern 410 may be determined based on a length 413 and a width 414 of a feed loop.

As illustrated in FIG. 4, it is possible to adjust the length 413 and the width 414 by disposing, on the UHF tag pattern 410, a first slot (s1) for adjusting the length 413 of the feed loop, a second slot (s2) for adjusting the width 414 of the feed loop, and a third slot (s3) for adjusting a length 412 of a radiator and thereby removing or adding a slot.

A reactance component Xₐ of impedance Zₐ of the UHF tag pattern 410 may be determined based on the length 413 of the feed loop. The reactance component Xₐ of antenna impedance Zₐ may increase according to an increase in the length 413 of the feed loop.

A resistance component Rₐ of impedance Zₐ of the UHF tag pattern 410 may be generally determined based on the length 413 and the width 414 of the feed loop. The resistance component Rₐ of impedance Zₐ of the UHF tag pattern 410 may increase according to an increase in the length 413 and the width 414 of the feed loop.

To perform conjugate matching of the tag antenna 400 according to the present invention with respect to the impedance Z_{c} of the RF frontend 121, the following operations may be performed.

In operation 1, the radiator of the UHF tag pattern 410 and the HF tag pattern 420 may be separate from each other by maximally using a size of a tag desired to be manufactured.

In operation 2, the length 413 of the feed loop may be adjusted to satisfy ‘Rₐ=R_{c}’, ‘Xₐ=−X_{c}’ in a predetermined frequency.

In operation 3, impedance may be adjusted by adjusting the width 414 of the feed loop depending on necessity.

In operation 4, when antenna impedance is adjusted and ‘Rₐ=R_{c}’ and ‘Xₐ=−X_{c}’ are satisfied in the predetermined frequency through repeating operations 2 and 3, the length 412 of the radiator may be adjusted to satisfy Zz Z_{α}=Z_{c}* in an operating frequency.

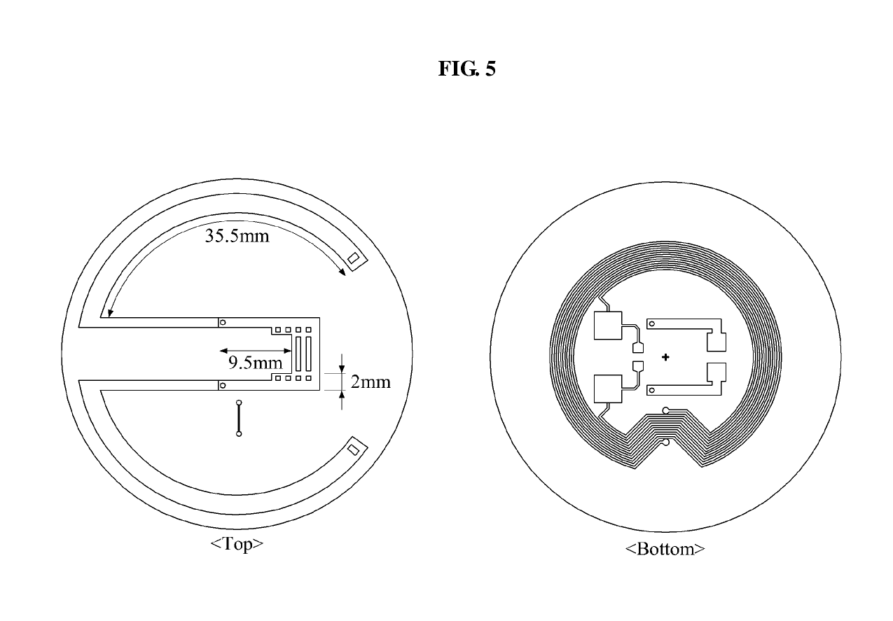

FIG. 5 is a diagram illustrating an example of a tag antenna according to an embodiment of the present invention.

In FIG. 5, the tag antenna is designed on an RF-4 PCB of 0.4 mm.

For example, as illustrated in FIG. 5, the UHF tag pattern 410 may have a length, “9.5 mm”, of a feed loop adjusted by the first slot (s1) and a width, “2 mm”, of the feed loop adjusted by the second slot (s2). Also, the radiator of the UHF tag pattern 410 may be adjusted by the third slot (s3) to thereby have a length of “35.5 mm”.

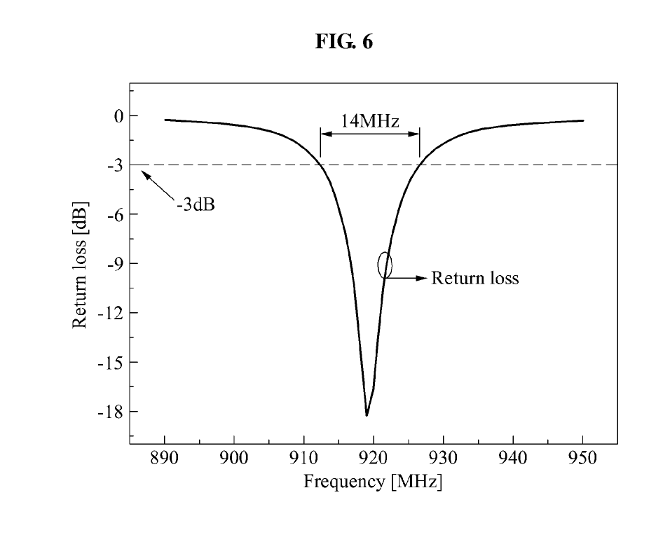

FIG. 6 is a graph illustrating an example of a result of testing a return loss according to an embodiment of the present invention.

The graph of FIG. 6 shows a result of testing a return loss about impedance Z_{c}=16−j154[Ω] of an RF frontend of a tag chip of a finally designed tag antenna.

It can be known from the graph that impedance matching with the RF frontend of the gap chip is well performed around 920 MHz.

According to embodiments of the present invention, there may be provided a tag antenna that may provide an HF and UHF application service using a single tag by miniaturizing a tag size through forming an HF tag pattern on one surface of a single PCB and forming a UHF tag pattern having a diameter greater than a diameter of the HF tag pattern on another surface of the single PCB, and by supplementing a decrease in the read range of a UHF tag by the UHF tag pattern.

An antenna provided by the present invention and an RFID tag using the antenna may be employed for a place requiring an integrated operation of HF/UHF RFID application service, for example, a company pass, a cafeteria management, a management of medical supplies, and a casino game room. For example, in the case of applying the present invention to the casino game room, it is possible to simultaneously provide an HF RFID service for reading within a restricted area, such as batting of a game chip, and a UHF RFID service for remote reading for detecting an illegal take-out of a game chip.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A tag antenna, comprising:
a substrate to form a high frequency (HF) tag pattern on a first surface and an ultra high frequency (UHF) tag pattern on a second surface different from the first surface; and
a feed terminal to supply power to each of the HF tag pattern and the UHF tag pattern.

2. The tag antenna of claim 1, further comprising:
a first matching unit to determine impedance of the HF tag pattern by adjusting at least one of the number of turns on the HF tag pattern and an LC resonant value by a capacitor.

3. The tag antenna of claim 1, further comprising:
a second matching unit to determine impedance of the UHF tag pattern by adjusting at least one of a length and a width of a feed loop that connects the UHF tag pattern and the feed terminal.

4. The tag antenna of claim 3, wherein the second matching unit comprises:
a first slot to adjust the length of the feed loop; and
a second slot to adjust the width of the feed loop, and
at least one of the first slot and the second slot is detachably attached to the feed loop.

5. The tag antenna of claim 4, wherein the second matching unit further comprises:
a third slot to adjust the length of the UHF tag pattern, and
when the impedance of the UHF tag pattern and impedance of HF tag pattern do not satisfy a predetermined condition, the third slot is detachably attached to the UHF tag pattern so as to have a length corresponding to an operating frequency.

6. The tag antenna of claim 3, wherein the second matching unit determines a reactance component in the impedance of the UHF tag pattern based on the length of the feed loop.

7. The tag antenna of claim 3, wherein the second matching unit determines a resistance component in the impedance of the UHF tag pattern based on the length of the feed loop and the width of the feed loop.

8. The tag antenna of claim 1, wherein the UHF tag pattern forms at least a portion of the HF tag pattern in a radial structure.

9. The tag antenna of claim 1, wherein the UHF tag pattern and the HF tag pattern are electromagnetically coupled.

10. The tag antenna of claim 1, wherein the UHF tag pattern performs conjugate matching with respect to impedance of a radio frequency (RF) frontend that converts an RF signal to direct current (DC) voltage.
